(19) United States
(12) Patent Application Publication
(10) Pub. No.: US 2015/0330934 A1
(43) Pub. Date: Nov. 19, 2015

(54) METHOD AND APPARATUS FOR MONITORING THE QUALITY OF ORE

(71) Applicants: Gennady Nikolaevich MASHEVSKIY, St. Petersburg (RU); Aleksandr Vladimirovich PETROV, St. Petersburg (RU); Sergei Aleksandrovich ROMANENKO, St. Petersburg (RU); Matti KLEMETTI, Pori (FI); Mika ETELAPAA, Mikkeli (FI)

(72) Inventors: Gennady Nikolaevich MASHEVSKIY, St. Petersburg (RU); Aleksandr Vladimirovich PETROV, St. Petersburg (RU); Sergei Aleksandrovich ROMANENKO, St. Petersburg (RU); Matti KLEMETTI, Pori (FI); Mika ETELÄPÄÄ, Mikkeli (FI)

(73) Assignee: Outotec (Finland) Oy, Espoo (FI)

(21) Appl. No.: 14/653,225

(22) PCT Filed: Dec. 28, 2012
(86) PCT No.: PCT/RU2012/001133

§ 371 Date: Jun. 17, 2015

(51) Int. Cl. G01N 27/30; G01N 27/416

(52) U.S. Cl. CPC G01N 27/302; G01N 27/416

(57) ABSTRACT

The invention relates to a method and an apparatus for monitoring the quality of an ore delivered to flotation concentration and the state of a slurry prepared from said ore. In the method, two or more working electrodes (6, 7, 8) featuring a cross sensitivity are immersed in the slurry to be monitored and the differences of potentials between each pair of electrodes is measured, whereby no reference electrodes are needed. The working electrodes (6, 7, 8) may comprise an argentite electrode, a platinum electrode and a molybdenum electrode, in which case the following differences of potentials between electrodes are being measured: Δ(Ag—Pt), Δ(Ag—Mo) and Δ(Pt—Mo).

### FIELD OF THE INVENTION

The invention relates to a method for monitoring the quality of an ore being delivered to flotation concentration

The invention also relates to an apparatus for the same purpose.

### BACKGROUND OF THE INVENTION

The chemistry of a flotation process depends on, for instance, the oxidation states and amounts of different minerals, galvanic interactions, chemicals and dissolved ions in the slurry. Mineralogy of sulphide ores from different deposits and even from the same deposit can vary drastically.

In flotation processes used in ore beneficiation plants, platinum electrodes are widely used for monitoring the electrochemical properties of the slurry. At the same time, glass membrane electrodes are used for measuring the pH of the slurry. Examples of flotation processes with continuous monitoring of the oxidation-reduction potential and pH of the slurry are presented in U.S. Pat. No. 3,883,421 and U.S. Pat. No. 4,011,072.

The electrode potentials of a platinum electrode and a glass membrane electrode are usually measured against a reference electrode, which can be, for instance, a silver chloride electrode (Ag/AgCl). Since voltage-measuring devices only determine differences in potentials, it is not possible to determine the potential of a single electrode.

FIG. 1 illustrates the principle of a measurement system according to the prior art. The system comprises a working electrode 1 and a reference electrode 2, which are immersed in a solution 3 the properties of which are being measured. The measurement system also comprises an operational amplifier 4 that produces an input signal for a voltmeter 5. The difference in voltage E between the working electrode 1 and the reference electrode 2 is measured and the result of the measurement is indicated by the voltmeter 5.

One of the main drawbacks of measuring equipment of prior art is the unreliability of reference electrode. The reasons behind this include, among other things, fouling of sensor element by mineral particles from the ore slurry and calcination of the surface of sensor element due to lime, when present.

### PURPOSE OF THE INVENTION

The object of the present invention is to overcome the problems faced in the prior art.

More precisely, the object of the present invention is to provide an improved method for monitoring the quality of an ore, especially when processing polymetal or gold containing ores, which may also contain sulphates or carbonates of iron (FeSO₄, FeCO₃) as well as pyrrhotine (FeₓS_{y}).

### SUMMARY

The method according to the present invention is characterized by what is presented in claim 1.

The apparatus according to the present invention is characterized by what is presented in claim 6.

The invention is based on the use of two or more working electrodes featuring cross sensitivity and the measurement of the differences of potentials between each pair of electrodes, whereby no reference electrodes are needed. The inventors have realized that the disadvantages and weaknesses of the prior art can be eliminated by implementing a potentiometric multisensor system based on metal and crystalline solid electrodes featuring cross sensitivity and pairwise measurements of differences of potentials between two electrodes, neither of which is a reference electrode.

In one embodiment of the invention, the working electrodes comprise an argentite electrode and a platinum electrode, and the difference of potentials between the electrodes Δ(Ag—Pt) is being measured.

In another embodiment of the invention, the working electrodes comprise an argentite electrode, a platinum electrode and a molybdenum electrode, and the differences of potentials between each pair of electrodes are measured, that is: Δ(Ag—Pt), Δ(Ag—Mo) and Δ(Pt—Mo).

The quality of ore and the state of the slurry prepared from said ore can be monitored at one or more locations preceding the flotation concentration process. Consequently, the conditions in the ore beneficiation can be adjusted on the basis of the measured differences of potentials between the working electrodes in order to reach optimum conditions during flotation.

When measuring the difference of potentials between an argentite electrode and a platinum electrode, if a positive difference of potentials is observed, a conclusion can be drawn that cations of bivalent iron are present in the slurry, when ores containing, for instance, ferrous carbonates or ferrous sulphates are being processed. On the other hand, if a negative difference of potentials is observed, a conclusion can be drawn that sulphide ions are present in the slurry, when pyrrhotine containing ores are being processed.

The apparatus according to the present invention comprises two or more working electrodes featuring cross sensitivity and means for determining the differences of potentials between each pair of electrodes without using a reference electrode.

The working electrodes may comprise, for instance, electrodes made of argentite (Ag₂S), platinum or molybdenum.

In one embodiment of the invention the means for determining the differences of potentials comprise a computing unit for computing the differences of Potentials between the pairs of electrodes based on measurement data received from the working electrodes.

The apparatus may also comprise a multisensor unit for transmitting the measurement data from the working electrodes to the computing unit.

### BRIEF DESCRIPTION OF THE DRAWINGS

The accompanying drawings illustrate embodiments of the invention and together with the description help to explain the principles of the invention. In the drawings:

FIG. 1 is a schematic illustration of a system for measuring oxidation-reduction potential by means of a working electrode and a reference electrode.

FIG. 2 is a schematic illustration of a measuring system according to the present invention, comprising three working electrodes.

FIG. 3 shows the relationship between the potentials of an argentite electrode and a platinum electrode.

FIG. 4 shows the relationship between Δ(Ag—Pt) and the potential of a molybdenum electrode.

FIG. 5 shows the concentrations of dissolved forms of iron (II) as a function of slurry pH value.

FIG. 6 shows the relationship between the potentials of Mo electrode and Ag₂S electrode.

FIG. 7 shows in the form of isolines the relationship between the potential of Mo electrode and the potentials of Pt and Ag₂S electrodes.

FIG. 8 shows in the form of isolines the relationship between the difference of potentials Δ(Pt—Mo) as a function of differences of potentials Δ(Ag—Pt) and Δ(Ag—Mo).

FIG. 9 shows examples of operating ranges in the form of electrode potentials measured against a reference electrode.

FIG. 10 shows examples of operating ranges in the form of differences of electrode potentials measured without a reference electrode.

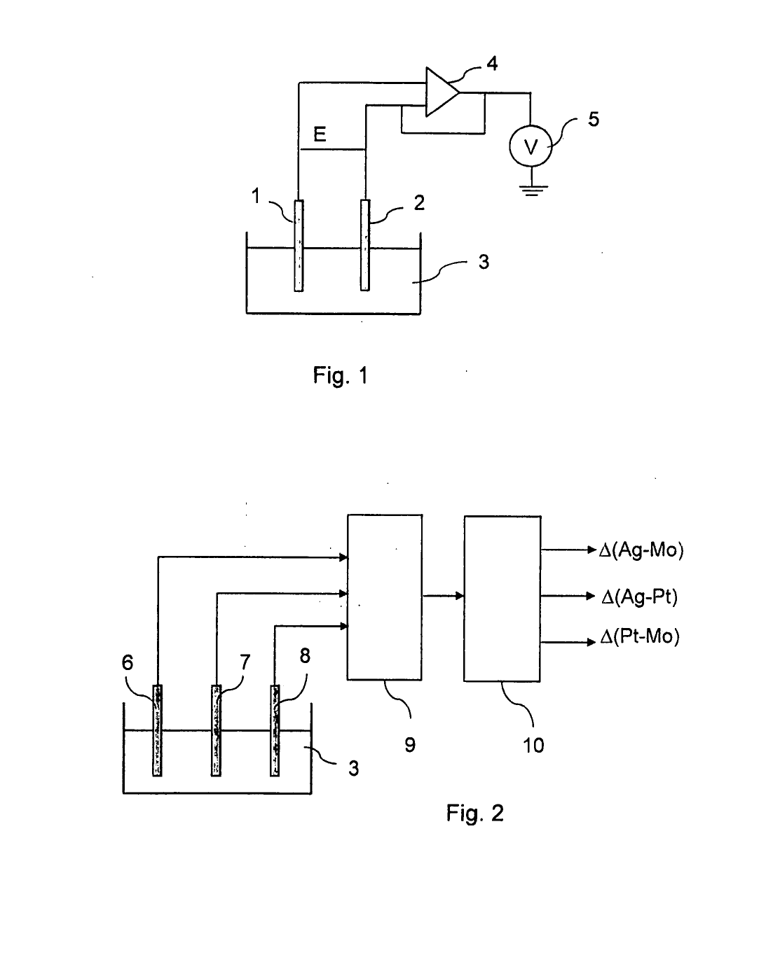

### DETAILED DESCRIPTION OF THE INVENTION

FIG. 2 shows an example of an apparatus for monitoring the electrochemical properties of a solution without using a reference electrode. The apparatus comprises three working electrodes 6, 7 and 8, which are immersed into a solution 3 the properties of which are being measured. In one embodiment of the present invention, the working electrodes 6, 7, 8 are an argentite (Ag₂S) electrode, a platinum electrode and a molybdenum electrode. The apparatus also comprises a, multisensor unit 9, which may be, for instance, of the type EMF-16, manufactured by Lawson Labs, Inc., USA. The multisensor unit 9 is connected to a computing unit 10 for calculation and presentation of the measured data. The multisensor unit 9 receives measurement data from the electrodes 6, 7 and 8 and transmits measurement signals to the computing unit 10, which creates differences of electrode potentials pairwise between the electrodes 6 and 7, 6 and 8, and 7 and 8, respectively. No ordinary reference electrode is needed to generate the differences of electrode potentials, which may comprise, for instance, Δ(Pt—Mo), Δ(Ag—Pt) and Δ(Ag—Mo).

Feasibility of applying this kind of method for monitoring the electrochemical properties of an ore slurry stems from an electrochemical model that has been developed on the basis of chemical reactions on the surface of an Ag₂S electrode in the presence of Na₂S:

2Ag⁰+S²⁻ [symbol] Ag₂S+2e⁻ (1)

2Ag⁰+HS⁻+OH⁻ [symbol] Ag₂S+H₂O+2e⁻ (2)

Electrode functions for these reactions are described by the following equations, accordingly:

φ₁=−0.688−0.029 lg[S²⁻],V (3)

φ₂=−0.282−0.029 lg[HS⁻]−0.029 pH,V (4)

For a platinum electrode, the following reactions are true:

S²⁻ [symbol] S⁰+2e⁻ (5)

HS⁻+OH⁻ [symbol] S⁰+H₂O+2e⁻ (6)

with the corresponding electrode functions:

φ₃=−0.480−0.029 lg[S²⁻],V (7)

φ₄=−0.074−0.029 lg[HS⁻]−0.029 pH,V (8)

Equations (3), (4), (7) and (8) result in a theoretical equation:

E_{Ag2S}=−0.208+E_{Pt},V (9)

where E_{Ag2S} is the potential of the argentite electrode and Eₚₜ is the potential of the platinum electrode.

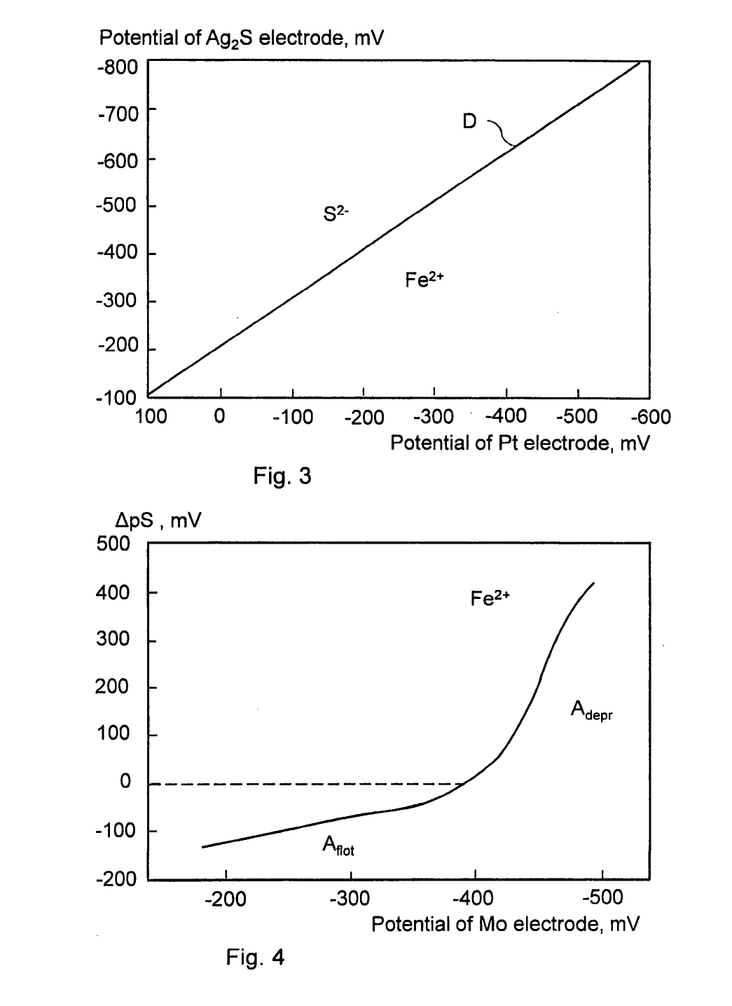

FIG. 3 shows the relationship between the potentials of an Ag₂S electrode and a platinum electrode in the form of straight line D.

Based on the equation (9), an algorithm for determining the electrochemical properties of ore slurry is determined:

ΔpS=E_{Ag2S}[measured]−(−0.208+E_{Pt}[measured]) (10)

Alternatively, ΔpS can also be expressed as Δ(Ag—Pt).

According to the equation (10), the calculated ΔpS value allows revealing two process particularities of the processed ores. Referring to FIG. 3, when ΔpS>0 is true, the slurry shows strong reducing properties. For instance, a positive value of ΔpS may indicate the presence of Fe²⁺ cations in the slurry, when processing an ore containing siderite (FeCO₃) or ferrous sulphate (FeSO₄). When ΔpS<0 is true, there are S²⁻ anions in the slurry, which is typical when processing pyrrhotine (FeₓS_{y}) containing ores.

Based on the structure of the developed model (10), no reference electrode is needed to determine the ΔpS value of the slurry but it is sufficient to measure the difference of potentials between the Ag₂S electrode and the Pt electrode.

There is, however, one disadvantage in monitoring the properties of an ore slurry based on the model (10). When ΔpS=0, the concentration level of sulphide ions in the slurry cannot be determined. For instance, when the Pt electrode potential is 0 mV and the Ag₂S electrode potential is −208 mV, ΔpS=0 mV. When the Pt electrode potential is −400 mV and the Ag₂S electrode potential is −608 mV, ΔpS=0 mV as well. In that case, however, a substantially higher concentration of S²⁻ anions is present in the slurry.

With a view to obtaining additional information about the quality of the processed ore, it is advisable to use a third metal electrode, for instance, an electrode made of molybdenum in addition to the argentite and platinum electrodes.

Thus, one embodiment of the new method for monitoring the electrochemical properties of an ore slurry comprises measuring the differences of potential pairwise between three electrodes, which are a platinum electrode, a molybdenum electrode and an argentite electrode.

The new method increases the reliability of determining the properties of an ore, because the need for a reference electrode is eliminated.

The difference in the behavior of an argentite electrode, a platinum electrode and a molybdenum electrode was analyzed using slurries of a copper-molybdenum ore from a commercially exploited deposit. Seven laboratory tests were conducted with different slurry preparation conditions, without reagents and with different combinations of reagent modes. The process was monitored using a potentiometric multisensor system that is able to provide process information within one minute. As a result of electrochemical measurements, a statistic array was produced including 9775 observations for eight electrode potentials. With the aim of revealing the relations that are of interest, a neural network modelling unit was used, which made it possible to reveal a correlation between ΔpS parameters and the Mo electrode potential. This correlation is shown in FIG. 4.

Two areas are distinguished in FIG. 4. A first area A_{flot} reflects the behavior of molybdenum electrode according to the following electrochemical reaction:

MoO₂+H₂O [symbol] MoO₃+2H⁺+2e⁻ (11)

The first area A_{flot} corresponds to the favorable conditions of sulphide mineral flotation.

A second area A_{depr} reflects the presence of a strong reducer in the slurry. In this particular example it is connected with the presence of Fe²⁺ cations in the slurry. The behavior of molybdenum electrode potential in the second area A_{depr} is described by the following electrochemical reaction:

Mo+3H₂O [symbol] MoO₃+6H⁺+6e⁻ (12)

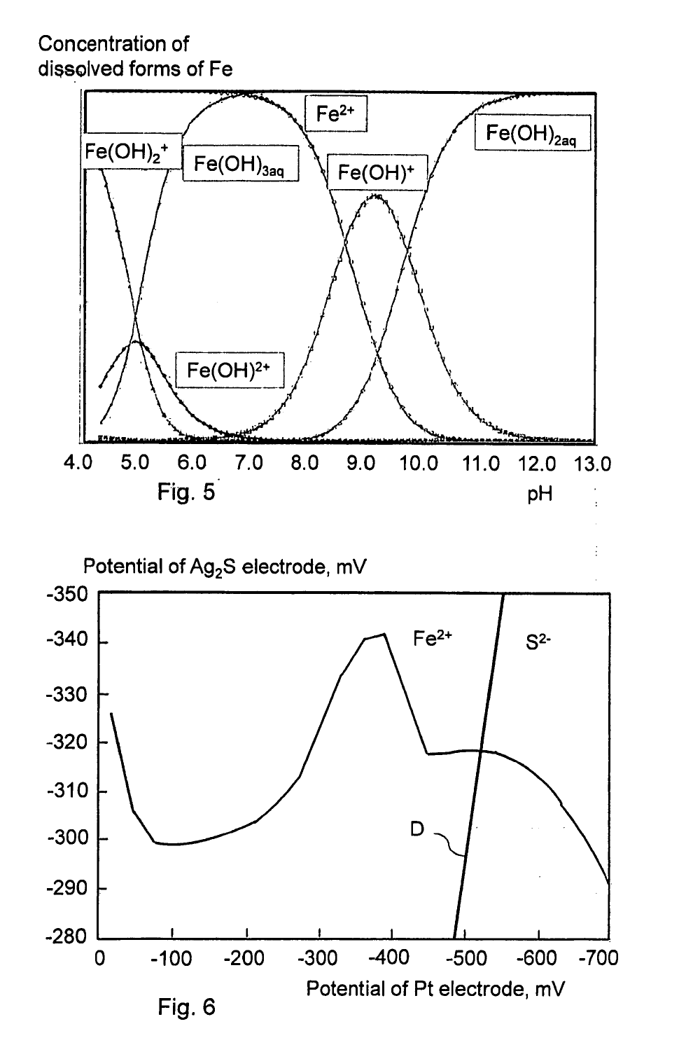

Appearance of Fe²⁺ and Fe(OH)⁺ cations in the slurry is an adverse factor for the flotation process, since these cations promote the formation of complex compounds with the collector used in the process (for instance, xanthate) and prevent efficient flotation of sulphide minerals. Such forms of [Fe(OH)X₂]⁻ complexes can be discovered especially in a pH range from 7.5 to 9.0. Such pH values are most common in processing polymetal ores. The relationship between the concentration of dissolved forms of iron (II) and the slurry pH is illustrated in FIG. 5.

Presence of iron (II) cations in the source slurry necessitates application of tools aimed at eliminating this factor, for instance, by using soda (Na₂CO₃), copper sulphate (CuSO₄), slurry aeration, or a complex-forming compound for iron cations, such as Na₂SiF₅ and Na₂S.

The neural network model based on the conducted experiments revealed a relationship between the potentials of an argentite electrode and a molybdenum electrode, which relationship is shown in FIG. 6. The Mo electrode is only weakly sensitive to the concentration of S²⁻ anions in the slurry, whereas the relationship between the potentials of the Ag₂S electrode and the Pt electrode is more notable. This makes it possible to recognize additional technical properties of the processed ore by measuring the differences of potentials between the argentite and molybdenum electrodes L(Ag—Mo) and the platinum and molybdenum electrodes A(Pt—Mo).

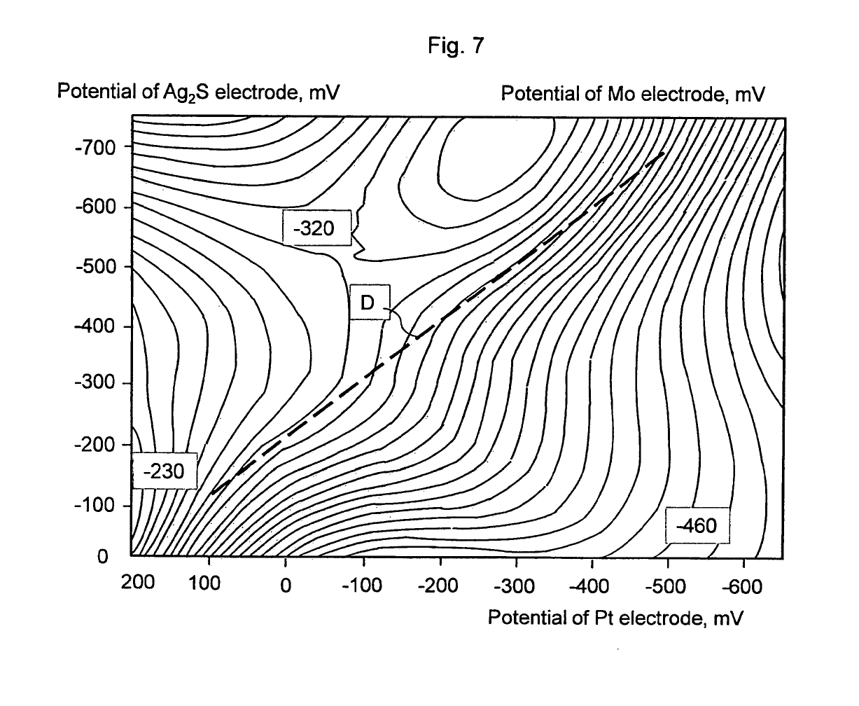

FIG. 7 illustrates the relationship between the potentials of a platinum electrode (on the x-axis), an argentite electrode (on the y-axis), and a molybdenum electrode (isolines), when each electrode—potential has been measured against a reference electrode. The figure also shows the dividing line D according to the equation (9), above which ΔpS<0 is true and below which ΔpS>0 is true. The numerical values of Mo electrode potential get more negative as the potential of Pt electrode gets more negative, but the relationship is not linear. As an example, three values of Mo electrode potential measured against a reference electrode are disclosed in the diagram.

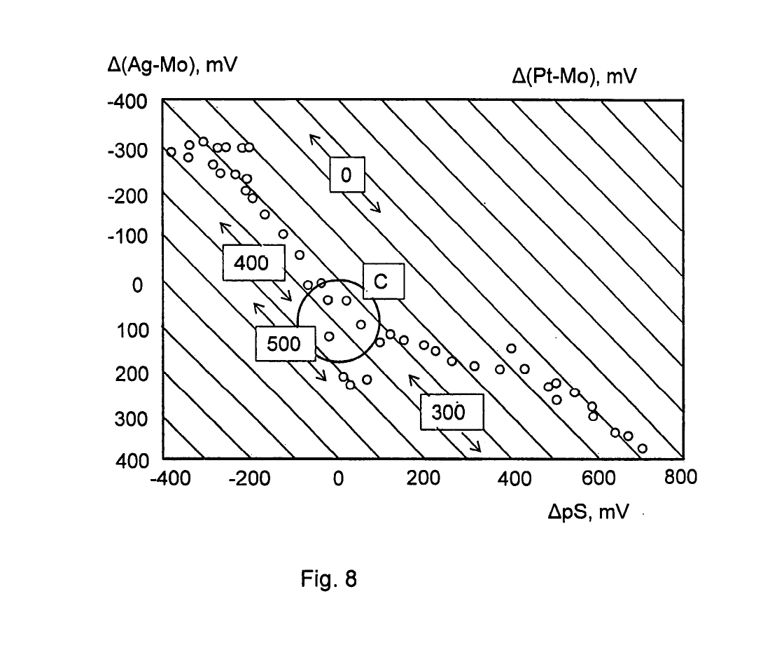

FIG. 8 shows the differences of electrode potentials of the same three electrodes in a coordinate system consisting of ΔpS on the x axis, Δ(Ag—Mo) on the y-axis, and Δ(Pt—Mo) in the form of isolines. The diagram illustrates a situation where the measurements are carried out without a reference electrode. The diagram also shows the locations of some measurement points and an empirically determined area of optimal flotation (circle C).

### Example 1

Different methods of measuring the electrochemical properties of ore slurry were compared in laboratory conditions using copper-molybdenum porphyry ore from a commercially exploited deposit. The main sulphide minerals of the ore were chalcopyrite (CuFeS₂—1.16% by weight) and pyrite (FeS₂—0.82% by weight). The source ore was ground to the size of 65%—0.074 mm. Butyl xanthate was used as a collector and methyl-isobutyl carbinol (MIBC) was applied as a frother.

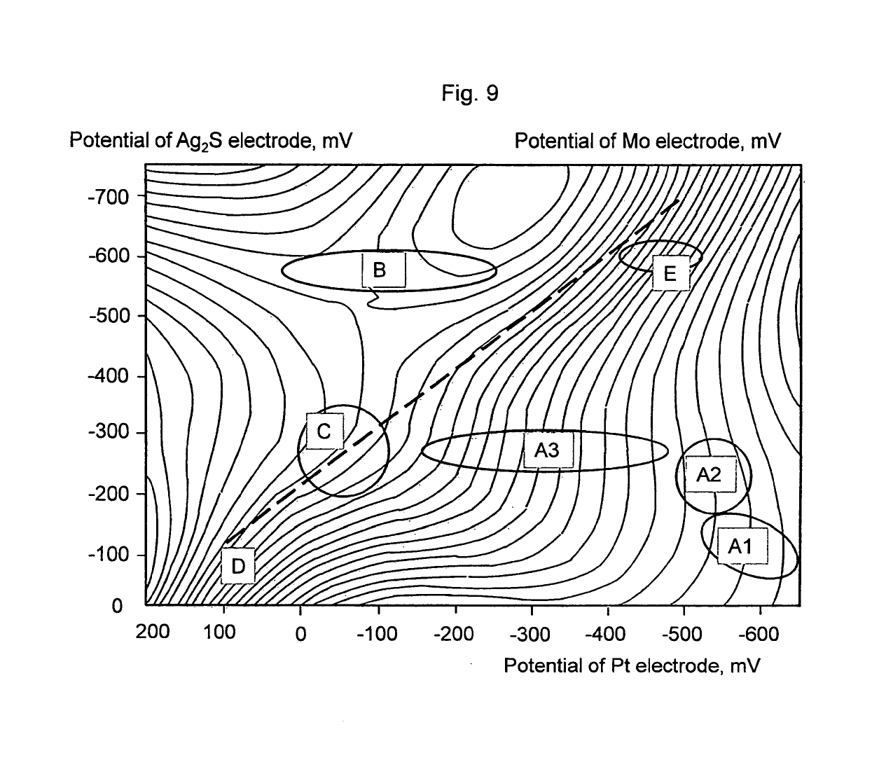

Measurements were carried out in connection with different kinds of treatments of the source ore. Electrode potentials measured against a reference electrode are shown in FIG. 9. References A1, A2 and A3 indicate the path of measurement results during a first experiment. Reference A1 denotes an area where the ore sample was not conditioned with reagents during grinding. Reference A2 denotes an area where Na₂S was dosed into the process or sulphide ions were present in the slurry. Reference A3 indicates the direction of change due to aeration of the slurry. Reference C denotes the optimum area of flotation, which should be reached after the addition of flotation chemicals.

For comparison, another test was conducted with the same ore but with addition of soda (Na₂CO₃) and K₂SiF₆ during grinding with a view to eliminate the adverse effect of Fe²⁺ cations on the process. Reference B denotes an area where Na₂S was dosed into the process or sulphide ions were present in the slurry. After addition of flotation chemicals the flotation was finally carried out in the optimum flotation area C.

In both test series A and B the measurement results finally lead to the same target area C, which is considered as the area of best flotation. In the test series A, the best results could be achieved by adding 200 g/t Na₂CO₃ and aeration of the slurry, which ensured the shift of the Mo electrode potential to an area around −300 mV.

The area below the dividing line D is an area of negative oxidation-reduction potentials of the slurry (reducing environment), which causes depression of sulphide minerals. The area above the dividing line D is an area of positive oxidation-reduction potentials of the slurry (oxidizing environment), which is unfavorable for the flotation of sulphide minerals. The flotation area C located in the proximity of the dividing line D represents the optimum values of oxidation-reduction potentials of the slurry, which cause the best flotation of sulphide minerals.

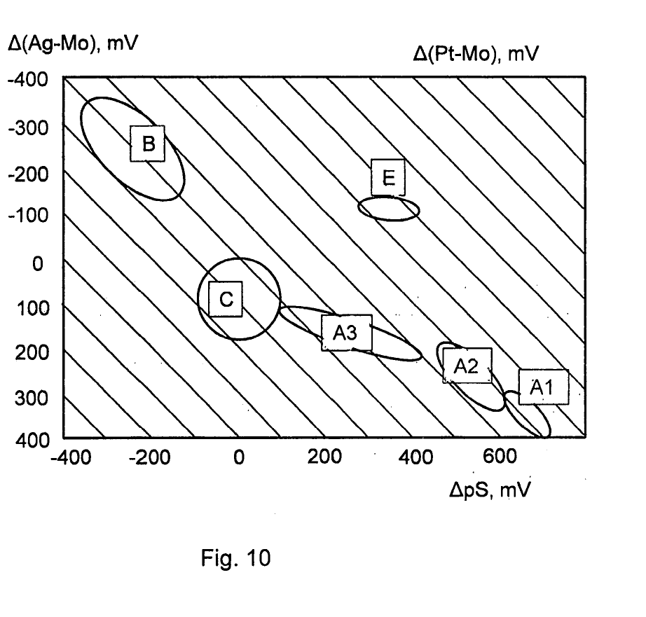

FIG. 10 shows the results of the same test series A and B when measuring the differences of potentials without a reference electrode. As indicated in FIG. 8, the value of Δ(Pt—Mo) decreases from isoline to isoline when moving away from the origin (−400, 400). When the value of Δ(Pt—Mo) is positive, the slurry has oxidizing properties. When the value of Δ(Pt—Mo) is negative, the slurry has reducing properties.

The comparative diagrams shown in FIG. 9 and FIG. 10 confirm the efficiency of applying the new method for monitoring the electrochemical parameters of the slurry when determining, for instance, the presence of iron cations, sulphide anions, and the degree of oxidation of an ore delivered to flotation.

### Example 2

Research was conducted using a sample of gold-containing sulphide ore. The gold content of the sample was 1 g/t. Pyrite (FeS₂) was the main sulphide mineral, its content in the ore being 2% by weight. Other sulphide minerals were also found in the ore: pyrrhotine, arsenopyrite, chalcopyrite, and bornite. However, the main particularity of this ore was the presence of iron sulphate (FeSO₄) in it, the content of which, together with iron hydroxide, is evaluated to be 0.8% by weight. The presence of iron sulphate in the ore immediately affects the electrochemical properties of the source slurry before the flotation.

The source ore sample was ground so far that 70% of ore particles were smaller than 0.074 mm. Butyl xanthate was used as a collector in the tests. Methyl-isobutyl carbinol (MIBC) was applied as a frother.

The electrochemical measurements of the source slurry gave locations in the area A2 of FIG. 9 and FIG. 10. The presence of Fe²⁺ cations in the slurry when testing this ore sample is completely confirmed in both FIG. 9 and FIG. 10. FIG. 9 represents the use of a conventional method for measuring the electrochemical parameters using a reference electrode. FIG. 10 represents the new method of measuring the electrochemical parameters of the processed ore without a reference electrode.

Introduction of Na₂CO₃ in an amount of 500 g/t and aeration of the slurry made it possible to change the electrochemical properties of the slurry and to shift them to the area C, ensuring the best flotation process results.

### Example 3

A sample of copper sulphide ore was the subject of laboratory experiments. The ore contained 40% by weight of pyrite and 5% by weight of chalcopyrite. The pyrrhotine content of the ore was 19% by weight. The source ore sample was ground so far that 80% of ore particles was smaller than 0.074 mm. After grinding, the source slurry was subjected to aeration in the presence of Na₂SO₃ and Aerofloat, which was used as a collector.

The results of electrochemical measurements of the source slurry fell upon the area E in FIG. 9 and FIG. 10.

It is almost impossible to make a conclusion on the presence of sulphide ions in the slurry because of the presence of pyrrhotine in the processed ore. This is clearly seen in FIG. 9, showing that in the area E the value of ΔpS is close to zero based on conventional measurement method with a reference electrode. According to the new measurement method performed without a reference electrode, such identification can be ensured by Mo electrode potential measurements in the system. The difference of potentials between the argentite and the molybdenum electrodes Δ(Ag—Mo) ensures such control (FIG. 10). The shift of difference of potentials Δ(Ag—Mo) from the reducing area E (area of depression of sulphide minerals) caused by the presence of pyrrhotine in the ore, to the optimum flotation area C is implemented by aeration of the slurry in a Na₂SO₃ environment with a reagent consumption of 2.0 kg/t.

Monitoring of the properties of a source ore by measuring the differences between electrode potentials gives information of the quality of the ore, which may significantly vary in the course of time. Better knowledge of the ore quality allows more precise dosage of chemicals and better optimization of the flotation process according to the ore used.

It is obvious to a person skilled in the art that with the advancement of technology, the basic idea of the invention may be implemented in various ways. The invention and its embodiments are thus not limited to the examples described above; instead they may vary within the scope of the claims.

1.-10. (canceled)

11. A method for monitoring the properties of an ore and the state of a slurry prepared from said ore, the method comprising the steps of immersing two or more working electrodes featuring cross sensitivity in the slurry and measuring the difference of potentials between each pair of working electrodes, none of which is a reference electrode, characterized in that the working electrodes comprise an argentite electrode and a platinum electrode and the measuring step comprises measuring the difference of potentials between said argentite electrode and said platinum electrode Δ(Ag—Pt).

12. The method according to claim 11, characterized in that the working electrodes comprise an argentite electrode, a platinum electrode and a molybdenum electrode and the measuring step comprises measuring the differences of potentials between each pair of electrodes, that is: Δ(Ag—Pt), Δ(Ag—Mo) and Δ(Pt—Mo).

13. The method according to claim 11, characterized by monitoring the properties of an ore and the state of a slurry prepared from said ore at a location that precedes flotation concentration of the ore.

14. The method according to claim 13, characterized by adjusting the conditions in ore beneficiation on the basis of the measured differences of potentials between the working electrodes in order to reach optimum conditions during flotation.

15. An apparatus for monitoring the properties of an ore and the state of a slurry prepared from said ore, the apparatus comprising two or more working electrodes featuring cross sensitivity, none of which is a reference electrode, and means for determining the differences of potentials between each pair of electrodes, characterized in that the working electrodes comprise an argentite electrode and a platinum electrode.

16. The apparatus according to claim 15, characterized in that the working electrodes comprise an argentite electrode, a platinum electrode and a molybdenum electrode.

17. The apparatus according to claim 15, characterized in that the means for determining the differences of potentials comprise a computing unit for computing the differences of potentials between the pairs of working electrodes based on measurement data received from the working electrodes.

18. The apparatus according to claim 17, characterized in that the apparatus also comprises a multisensor unit for transmitting the measurement data from the working electrodes to the computing unit.
